(19) United States
(12) Patent Application Publication
(10) Pub. No.: US 2024/0286194 A1
(43) Pub. Date: Aug. 29, 2024

(54) METHOD FOR FABRICATING A MIRROR BY 3D PRINTING

(71) Applicant: SAFRAN REOSC, Saint Pierre Du Perray (FR)

(72) Inventor: Jacques RODOLFO, Saint Pierre Du Perray (FR)

(73) Assignee: SAFRAN REOSC, Saint Pierre Du Perray (FR)

(21) Appl. No.: 18/573,353

(22) PCT Filed: Jun. 22, 2021
(86) PCT No.: PCT/FR2021/051136

§ 371 Date: Dec. 21, 2023

(51) Int. Cl. B22F 10/18; B22F 3/10; B22F 10/62; B22F 10/64; B28B 1/00; B28B 11/24; B33Y 10/00; B33Y 30/00; B33Y 40/20; C04B 35/634; C04B 35/638; C04B 35/64

(52) U.S. Cl. CPC B22F 10/18; B22F 3/1021; B22F 10/62; B22F 10/64; B28B 1/001; B28B 11/243; B33Y 10/00; B33Y 30/00; B33Y 40/20; C04B 35/634; C04B 35/638; C04B 35/64; B22F 2998/10; C04B 2235/3217; C04B 2235/3826; C04B 2235/3873; C04B 2235/602

(57) ABSTRACT

A method for fabricating mirrors includes a step of constructing the mirrors by 3D printing on a mold arranged on a tray of a 3D printer, using fused filament fabrication (FFF) printing technology. The mold has a free surface matching an optical surface of a mirror to be fabricated. The method includes depositing, in consecutive layers on the mold, a fused polymer filament loaded with a powder of a ceramics. The deposition starts with the optical surface of the mirror on the free surface of the mold. The method further includes a step of disassembling the mirror and the mold; a step of debinding the ceramic powder; and a step of sintering the ceramic powder in order to solidify the mirror.

### FIELD OF THE INVENTION

The invention is from the field of fabrication of high-precision mirrors and in particular mirrors of ceramics like silicon carbide (SIC), alumina, cordierite, silicon nitride Si₃N₄ or of metals like aluminum and proposes a fabrication method for such a mirror by 3D printing.

### DESCRIPTION OF RELATED ART

Current methods for fabrication of mirrors in particular of ceramic SiC use a substrate made by a sintering technique. They comprise the preparation of a powder, fabrication of a SiC block by pressure on the powder, machining the SiC block to shape it and then sintering for welding the grains of the material to each other or infiltration of binding material like silicon. The resulting substrate is thus shaped, but not to a sufficient precision. Therefore, it then needs to be followed by grinding of the optical surface and interface zones and then by polishing of the optical surface, depositing a polishing layer and finalization of the polishing.

The steps of polishing consists of improving the shape of the mirror and the roughness thereof until reaching a necessary surface state for optical applications. These steps are long and costly and require particularly costly machines and tools suited to polishing these mirrors, in particular in the case of the aforementioned ceramics and especially silicon carbide.

All these steps must be repeated each time one wants to make a new copy of the mirror. They are time consuming and are not suited for fabrication of a large number of copies of a single mirror, especially if the surface is difficult to polish as in the case of an aspherical or free-form mirror.

### Problem to be Solved

These known solutions do not allow replicating mirrors, and each mirror made has to go through the polishing phase.

Further, producing mirrors by classical additive fabrication is known, meaning by starting with the base and finishing with the mirror surface, but the polishing operation remains necessary, since the additive fabrication does not allow reaching the desired surface state during fabrication.

The problem to be resolved is thus to find an additive fabrication method which generates a part with a surface state having the quality level sought.

### BRIEF SUMMARY OF THE INVENTION

In light of the prior art, the present application proposes a method with which to produce an optical quality surface sufficiently precise in shape and roughness for avoiding polishing operations on the resulting surface. In order to do that, the principle of the invention is to use a mold equipped with a surface complementary to the optical surface of the mirror to be made as molding surface in a 3D printing method.

More precisely, the application proposes a mirror fabrication method which comprises the step of construction of said mirrors by 3D printing on a mold arranged on a tray of a 3D printer using a printing technology by deposition of fused material known under the acronym FFF, for Fused Filament Fabrication, where said mold comprises a free surface complementary to an optical surface of a mirror to be fabricated, and where said construction comprises steps of:
Depositing on the mold successive layers of a polymer filament loaded with a powder of a fused ceramic and/or metal material, said deposit starting on the optical surface of the mirror on said free surface of the mold;
Disassembling the mirror and the mold;
Debinding ceramic and/or metallic powder; and
Sintering the ceramic and/or metallic powder in order to solidify the mirror.

The characteristics disclosed in the following paragraphs may, optionally be implemented. They may be implemented independently of each other or in combination with each other.

The ceramics advantageously comprises silicon carbide SiC and/or silicon nitride Si₃N₄ and/or alumina and/or cordierite.

The method from the invention applies particularly well to these materials that are especially hard and difficult to polish but with which high-performance materials can be implemented because of the mechanical and thermal characteristics thereof.

The metal may in particular be aluminum which is difficult to polish because it requires diamond machining machines which are costly.

The method may comprise a step of removing the mirror and mold assembly from the machine and a step of separating the mold and mirror.

The debinding step eliminates the polymer that constitutes a binding for the ceramic or metal material which comprises a step of chemical debinding and/or a thermal treatment in a furnace at a suitable temperature for eliminating the polymer.

Should the polymer binder comprise a polyolefin, the debinding step may comprise a chemical debinding by soaking the mirror in an acetone bath followed by said thermal treatment.

For a concave mirror, the 3D printer may be programmed for depositing the filament on the mold on a series of constant level lines by starting from the lower surface of the mold whereas for a convex mirror, the 3D printers program for depositing the filament on the series of constant level lines starting from the highest part of the mold.

Prior to the construction of said mirror, the method may comprise a step of positioning the mold made by previously printing an imprint on the tray of the machine in order to receive a base of the mold or by using a tool whose position is referenced relative to the coordinates of the machine.

Preferably, the depositing step comprises, at least before the depositing of a first filament layer, heating the mold to a temperature between 30° C. and 80° C. suited to adhering the first layer of filament onto the mold and the reproduction of the surface state of the mold by said first layer.

In the case where the shape or the residual roughness/porosity of the sintered material is too great compared to the application, a step of depositing a finishing layer and polishing thereof may be done on an optical surface of the mirror after sintering.

Such a finishing layer made by depositing an amorphous material such as glass is in particular desirable when the sintered material has a surface porosity.

The method may be preceded by one or several steps for fabrication of a mold that may or may not be reused and for which the geometry of the mold and the shape of the complementary surface are determined in order to take account of the bias of the fabrication chain like a shrinkage produced by the printing of the mirror and/or shrinkage produced by sintering of the mirror.

The method advantageously comprises a polishing of the mold for achieving a roughness below 5 nm RMS.

The mold may be made of vitroceramic glass, aluminum, ceramic, silicon carbide, cordierite, alumina Si₃N₄ or any other material resistant to the temperature of depositing the filament and having a roughness below 5 nm RMS.

According to another aspect, a mirror is proposed obtained by means of the method according to the invention comprising on a first side an optical surface and on a second side an attachment profile.

### BRIEF DESCRIPTION OF THE DRAWINGS

Other characteristics, details and advantages of the invention will appear upon reading the following detailed description, and the analysis of the attached drawings, on which:

FIG. 1 shows a view of a preliminary step for fabrication of a mirror according to the application on a 3D printing machine.

FIG. 2 shows a view of a first step for fabrication of a mirror according to the application on a 3D printing machine.

FIG. 3 shows a view of a second step for fabrication of a mirror according to the application on a 3D printing machine.

FIG. 4 shows a view of a third step for fabrication of a mirror according to the application on a 3D printing machine.

FIG. 5 represents a schematic view of a step of separation of a mirror and a mold from the application.

FIG. 6 represents a schematic view of a step of debinding a mirror from the application.

FIG. 7 represents an example of a mirror from the application in perspective from above.

FIG. 8 represents a sequence diagram for a method from the application.

### DETAILED DESCRIPTION OF THE INVENTION

The drawings in the description below contain, for the most part, elements of a definite nature. They could therefore not only serve to make the present invention better understood, but also contribute to the definition thereof, as applicable.

The mirror fabrication method from the present application aims to replace the traditional steps of fabrication of the sintered ceramic or metallic substrate and of polishing with a printing operation by using an additive fabrication machine for creating the mirror from a plastic binder filament bearing a ceramic or metal by replicating it on a mold.

To make the ideas more concrete, in the case of a high-precision mirror based on sintered substrate, the conventional methods comprise fabrication of a mirror substrate comprising a shape defect less than 5 μm RMS (RMS is root of the mean square) and a roughness less than 1 μm RMS.

One or more steps of polishing the substrate in the mirror are done in order to get a shape defect less than 100 nm RMS and a roughness less than 5 nm RMS.

Finally an amorphous finishing layer is deposited in particular to compensate for the porosity of the substrate. This layer is then polished such that the finished mirror comprises a shape defect less than 10 nm RMS and a roughness less than 2 nm.

The present invention aims to simplify the fabrication of such mirrors and as seen previously to eliminate the polishing of the mirror while aiming to get a shape defect less than or equal to 100 nm RMS and a roughness less than or equal to 5 nm RMS.

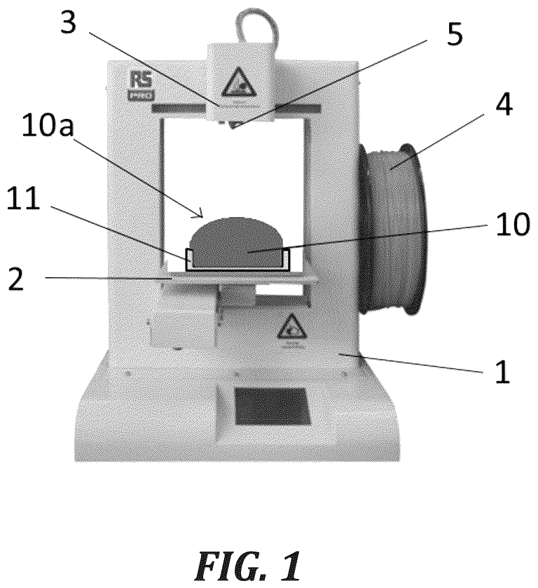

To do that, a mold 10 shown in FIG. 1 is fabricated. This mold comprises an upper surface representing the complementary shape of the optical surface of the mirror that one wants to make. The complementary surface with the desired curvature of the mirror is going to be provided with the roughness targeted for the mirror. Further, the shape of the complementary surface of the mold must consider deviations resulting from the method and in particular the shrinkage which is going to occur during printing and then sintering of the mirror and which may change the shape of the optical surface of the mirror.

The mold may be fabricated in vitroceramic glass known in particular under the brand Zerodur, aluminum or any material which allows achieving the desired polishing and roughness specification.

The mold is preferably a reusable mold with which to fabricate a series of mirrors.

Still according to FIG. 1, the mold 10 is placed on a tray of the 3D printer 1 using the fused filament fabrication (FFF) technology. The mold is precisely positioned on the machine because the printing must be done on the surface 10a of the mold complementary to the optical surface of the mirror. The precise positioning of the mold may be done by printing an imprint 11 in advance on the tray 2 of the machine in order to receive and hold the base of the mold in position or by using a tool whose position is referenced relative to the coordinates of the machine.

The printing machine 1 is a printing machine which uses a polymer filament 4 loaded with a fine powder of a ceramic or metal suited to the implementation of a mirror and in particular a material like silicon carbide SiC, silicon nitride Si₃N₄, alumina, cordierite, or aluminum. The polymer filament constitutes a binder for the powdered ceramic or metal.

The filament 4 is going to be deposited fused by means of a nozzle 5 driven by a motorized device 3 along two horizontal axes for depositing filament layers whereas the tray 2 is going to move along a vertical axis for implementing the successive layers of the mirror.

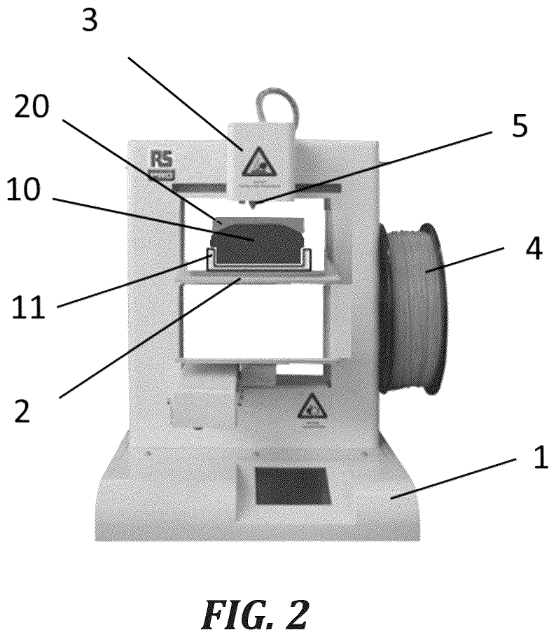

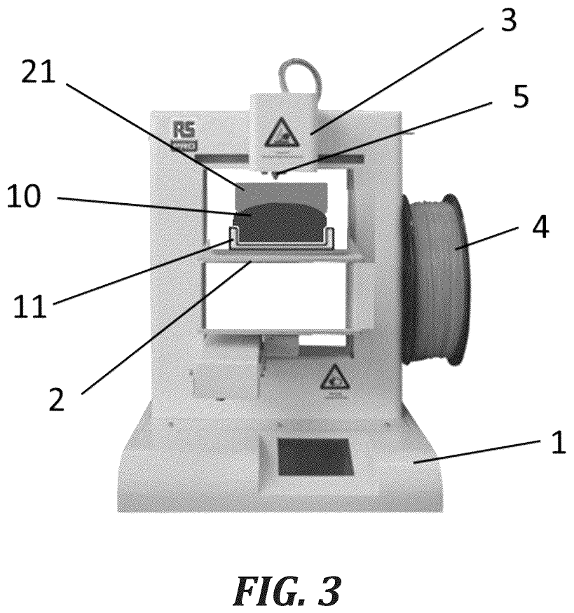

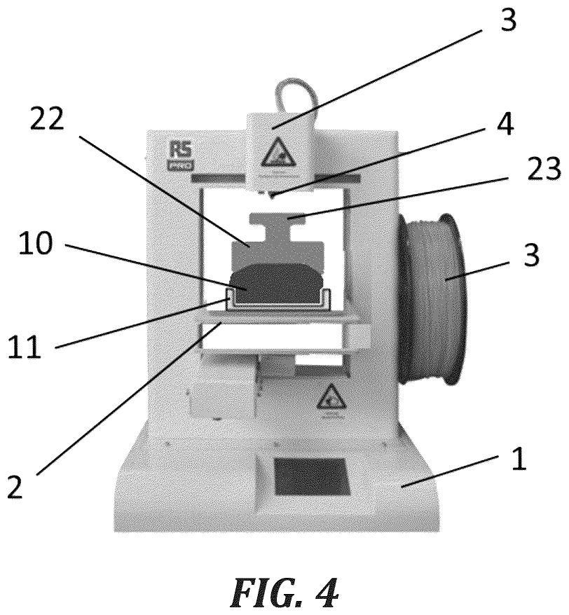

In a first step according to FIG. 2, the optical surface 20 of the mirror is made on the upper surface 10a of the mold and then, according to FIGS. 3 and 4 the 3D printing is done for implementing the body 21 of the mirror 22 and then the rear part 23 thereof.

The binder is for example a thermoplastic such as PLA (polylactic acid), a polyolefin or polystyrene as known in the field and this binder is going to be eliminated after printing the mirror.

In the case of the standard 3D machine with three axes, since the surface 10a of the mold complementary to the optical surface is not in general a flat surface but a concave or convex surface, the programming of the depositing machine is different from the programming of a machine making a part on a flat tray.

In fact, a technical problem is that the current machines print objects in a working volume that is assumed to be unobstructed. The print head of the machine therefore moves without constraint in the plane of each layer to be printed. The presence of the mold demands that the operation of the machine be reconsidered in order to change the movement of the head 3 comprising the nozzle 5 for depositing the fused filament 4 because the shape of the mold 10 constitutes an obstacle during movement of the head.

In the context of the invention, the travel path of the head takes into account the volume occupied by the shape of the mold, the volume of the printhead of the machine and the movement kinematics thereof. The traditional strategy of slicing in layers and the corresponding algorithm of the machine cannot be used and the programming thereof is consequently reconsidered.

In order for the head depositing the filament, which must remain at a distance from the surface to be covered of order 0.2 mm to 1 mm, to avoid coming into contact with the zone of the mold which is located above the layer being printed, instead of movements of the head along parallel lines, the machines driving software is configured for moving the head on increasing level lines by starting from the lowest point or surface of the mold. For example, the machine is going to be programmed for depositing the filament on concentric circles of smaller and smaller diameter on a mold whose upper surface is circular convex or on circles of increasing diameter for a mold whose upper surface is circular concave.

In the case of a mirror with a more complex shape, the head is going to move to make deposits on level lines of suitable shape always starting from the lowest point or surface of the mold.

Other trajectories are possible according to the shape of the optical surface of the mold and the geometry sought for the mirror.

It should be noted that the kinematics of the machine is not final. There are in particular machines which allow a movement of the nozzle along three axes which can be used in the scope of the invention.

In particular, in the case where the curvature of the mirror is such that the dimensions of the head could lead to possible contact of the head with the wall of the mold, a machine where the head is secured on a robotic arm with at least five axes or on a numerically controlled machine with at least five axes is going to be used.

The method thus covers the kinematics of placement of different filaments and in particular the implementation of an inclination of the system for displacement of the nozzle in order to remain perpendicular to the surface.

In current 3D FFF machines, the material is deposited on a tray designed for favoring adhesion of the first layer deposited on the tray mainly by using a heating tray or an adhesion promoter. During printing on a mold, the adhesion must be maintained so that the deposited mirror reproduces the surface state of the mold.

In order to allow an adhesion of the first layer on the mold, the mold is going to be brought to a temperature suited for not cooling the pasty filament leaving the nozzle too quickly.

For this consideration, the mold is preheated until reaching a suitable temperature as a function of the material of the filament, starting from around 30° C. and up to 80° C. according to the filaments used. This temperature could be maintained throughout the deposit in order to make it homogeneous.

Once the mirror is made by depositing on the mold, the mold and the mirror are together taken off the machine.

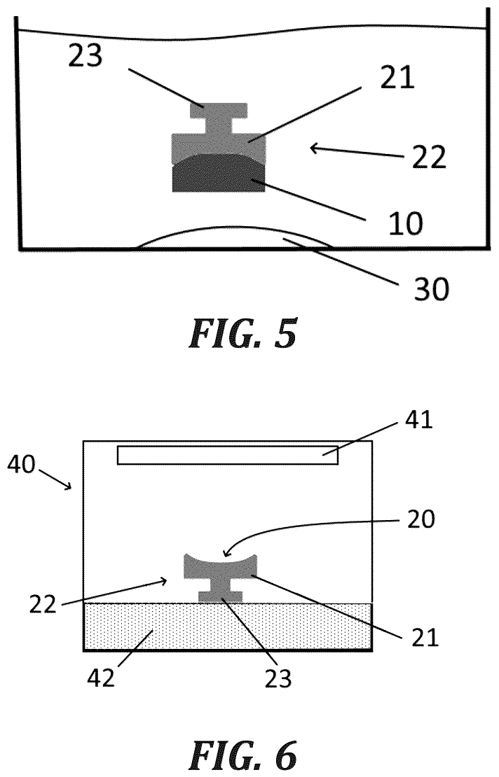

In a subsequent step, the mirror is separated from the mold without harm to the optical surface in contact with the mold. To do that, a method can in particular be used such as an ultrasonic method, for example by placing in an ultrasonic generator bath 30 as shown in FIG. 5, or a thermal method.

The implementation of the mirror next comprises an operation for elimination of the polymer, called debinding.

This debinding may be done by combining a chemical step, for example using an acetone bath, and then thermal treatment in a furnace 40 shown schematically in FIG. 6 with a suitable heating device 41.

For information, for a polyolefin/alumina filament, a furnace 40 suited for producing a temperature of about 500° C. in stages is used, where the mirror is placed on a hearth or a bed of refractory material 42. Other temperatures and heating profiles may be used according to the materials of the filaments used.

The debinding which, depending on the binder, may produce sublimation, evaporation or pyrolysis of the binder, could possibly be done directly thermally according to the binder used and according to the recommendations of the manufacturer of the filament.

Once the debinding is done, the method comprises sintering of the material according to a thermal cycle suited to the material for example rising from 20° C. to 1550° C. in 15 hours and holding for four hours, either in the furnace 40 if it is suited to the temperatures needed or in another furnace.

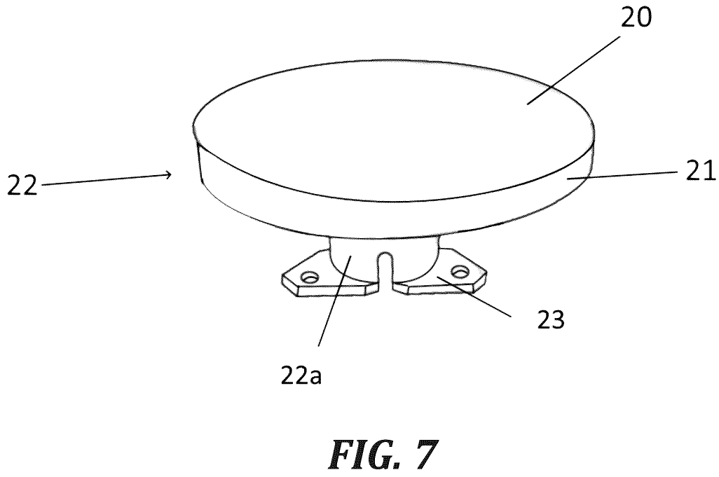

An example of a finished mirror 22 is shown in FIG. 7 where the bottom of the optical surface 20, which is for example concave or convex, the body of the mirror 21, and the attachment foot 22a which is provided with wings 23 with holes for attachment on a carrier device can be seen from the top to the bottom.

In order for the geometry of the printed object to correspond to the desired final shape and because of the phenomena of shrinkage during printing and during thermal processing of the printed object, the method must comprise a behavioral model of the part during fabrication thereof and an inversion of the calculations from this model in order to determine the shape the mold should have in order that the mirror have a correct geometry at the end of the method.

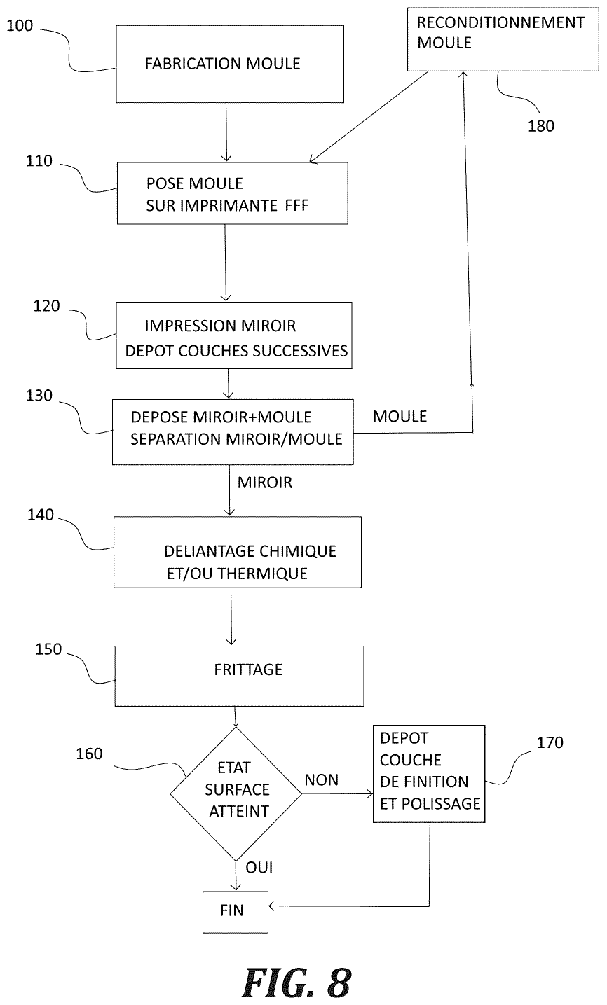

FIG. 8 schematically shows the steps of the method starting from the fabrication of the mold 100, where the method comprises:
in step 110, placing the mold on the printer;
in step 120, printing the mirror;
in step 130, removing the mold and the mirror, and separating the mold and the mirror; the mold could be reconditioned in step 180 in order to be reused;
in step 140, chemical and/or thermal debinding of the mirror;
in step 150, sintering of the mirror and then;
either the end of the process if the mirror has reached the desired surface state and optical characteristics, or a step 170 of depositing and polishing a finishing layer if reworking of the mirror is necessary and the end of the process.

The mirror is not limited to the example shown and in particular the mold may be concave and the mirror convex all while remaining within the scope of the invention.

1. A mirror fabrication method having a step of constructing said mirrors by 3D printing on a mold arranged on a tray of a 3D printer using a printing technology by deposition of fused material (FFF), said mold including a free surface complementary to an optical surface of a mirror to be fabricated, said construction further comprising the steps of:
depositing on the mold successive layers of a polymer filament loaded with a powder of a fused ceramic and/or metal material, said deposit starting on the optical surface of the mirror on said free surface of the mold;
disassembling the mirror and the mold;
debinding the ceramic and/or metallic powder; and
sintering the ceramic and/or metallic powder in order to solidify the mirror.

2. The mirror fabrication method according to claim 1, wherein the ceramic comprises silicon carbide SiC and/or silicon nitride Si3N4 and/or alumina and/or cordierite.

3. The mirror fabrication method according to claim 1, wherein the metal is aluminum.

4. The mirror fabrication method according to claim 1, further comprising a step of removing the mirror and mold assembly for the machine and a step of separating the mold and mirror.

5. The mirror fabrication method according to claim 1, wherein the debinding step eliminates the polymer that constitutes a binding for the ceramic and/or metal material, which comprises a step of chemical debinding and/or a thermal treatment in a furnace at a suitable temperature for eliminating the polymer.

6. The mirror fabrication method according to claim 4, wherein the polymer binder comprises a polyolefin.

7. The mirror fabrication method according to claim 1, wherein the 3D printer is programmed for depositing the filament on the mold on a series of constant level lines by starting from the lower surface of the mold whereas for a convex mirror, the 3D printer's program for depositing the filament on the series of constant level lines starting from a highest part of the mold.

8. The mirror fabrication method according to claim 1, further comprising, prior to the construction of said mirror, a step of positioning the mold made by previously printing an imprint on the tray of the machine in order to receive a base of the mold or by using a tool whose position is referenced relative to the coordinates of the machine.

9. The mirror fabrication method according to claim 1, wherein the depositing step comprises, at least before the depositing of a first filament layer, heating the mold to a temperature between 30° C. and 80° C. suited to adhering the first layer of filament onto the mold and the reproduction of the surface state of the mold by said first layer.

10. The mirror fabrication method according to claim 1, further comprising a step of depositing a finishing layer and polishing thereof on an optical surface of the mirror after sintering.

11. The mirror fabrication method according to of claim 1 preceded by one or several steps for fabrication of a mold for which the geometry of the mold and the shape of the complementary surface are determined in order to take account of the bias of the fabrication chain like a shrinkage produced by the printing of the mirror and/or shrinkage produced by sintering of the mirror.

12. The method according to claim 11, further comprising a polishing of the mold for achieving a roughness below 5 nm RMS.

13. The method according to claim 11 wherein the mold is made of vitroceramic glass, aluminum, ceramic, silicon carbide, cordierite, alumina Si3N4 or any other material resistant to the temperature of depositing the filament and having a roughness below 5 nm RMS.

14. A mirror manufacture by the method of claim 1, the mirror comprising on a first side an optical surface and on a second side an attachment profile.

15. The mirror fabrication method according to claim 6, wherein the debinding step (140) may comprise a chemical debinding by soaking the mirror in an acetone bath followed by said thermal treatment.

16. The mirror fabrication method according to claim 11, wherein the mold is reusable.
